(19) United States
(12) Patent Application Publication
(10) Pub. No.: US 2007/0043677 A1
(43) Pub. Date: Feb. 22, 2007

(54) Point of sale product authorization

(75) Inventor: Michael Drapkin, Airmont, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: IDT Corporation

(21) Appl. No.: 11/205,927

(22) Filed: Aug. 17, 2005

(51) Int. Cl. G06F 17/60

(52) U.S. Cl. 705/52

(57) ABSTRACT

There is provided a system for authorizing a sale of a product at a point of sale. A database has an activation key table. An input device inputs an activation key during a point of sale transaction. A backend system compares the activation key with the activation key table to determine if a copy of the activation key is found in the activation key table and denies the point of sale transaction if the copy of the activation key is not found in the activation key table.

### BACKGROUND OF THE INVENTION

1. Field of the Invention

The present disclosure relates to an authorization of a product at a point of sale area, and more particularly, to an installation and activation of the product.

2. Description of the Related Art

Retailers sell product, such as software, either to specialized markets or the general public. One problem associated with retailing is that of “shrinkage”, i.e., the problem of an actual inventory being smaller than the inventory that should be on hand, according to the paperwork. Shrinkage can be the result of theft, or such other factors as accounting errors, damaged articles being discarded, and inventory errors.

Retail inventory shrinkage is a significant part of the retailer's overhead costs. Conventional solutions force the retailer to invest in inventory software to track shrinkage, because the retail product boxes have inherent value even prior to sale. Furthermore, conventional solutions require that valuable software be locked in secure cases in the retail store, requiring sales persons to summon a manager in order to unlock and retrieve the software produce. In many cases, the product must then be physically and securely handled by store personnel until the sale has been completed at the point of sale, which is often some distance away from the secure case. Furthermore, the packaging containing the product is typically designed to be larger to aid theft prevention (i.e., harder to physically carry it out of a secured area). However, this larger packaging occupies a larger retail space, reducing the amount of product a retailer can display at any one time.

Therefore, there is a need to sell a product, such as software, that has no intrinsic value prior to sale, while reducing product handling overhead, such as is used in conventional retail operations.

### SUMMARY OF THE INVENTION

The present disclosure provides for a system for or authorizing a sale of a product at a point of sale. A database has an activation key table. An input device inputs an activation key during a point of sale transaction. A backend system compares the activation key with the activation key table to determine if a copy of the activation key is found in the activation key table and denies the point of sale transaction if the copy of the activation key is not found in the activation key table.

In various embodiments, the activation key table has a plurality of attributes, comprising an acquired attribute, and an activation attribute. The backend system sets the acquired attribute to a positive acquired attribute after an authorized sale of the product. The activation key table is received from a vendor. A serial identification (ID) table contains a serial ID, wherein the serial ID corresponds to a stored activation key in said activation key table. The input device has a merchant identifier and a terminal identifier. An activation key conveyor couples said input device and said backend system, wherein the activation key conveyor is selected from the group consisting of a financial services transport, a public internet, and a host to host connection. A packaging of said product has a magnetic strip readable by said input device, wherein said activation key is contained within said magnetic strip. The input device is a credit card reading machine.

The present disclosure further provides for a system for authorizing an offline installation of a product with a key management system. A database has an activation key table and a serial ID table. An input device inputs an activation key during an offline installation. A customer service is coupled to said database. A backend system compares the activation key with the activation key table to determine if the activation key is found in the activation key table and denies the installation if said activation key is not found in the activation key table. The backend system conveys an offline code that correlates to the stored serial ID within said serial ID table to the customer service, and the offline code is associated with the activation key.

In various embodiments, the activation key table has a plurality of attributes, comprising an acquired attribute and an activation attribute. The backend compares an activation attribute associated with an activation key. If the activation attribute is negative, the backend system activates said product. If the activation attribute is positive, the backend system stops an activation of the product. The activation attribute is set to positive if the backend system activates the product. The product has intelligence. The product has an embedded serial ID, wherein the serial ID is compared against a serial ID associated with an activation key of said product in a serial ID table to enable installation of the product.

The present disclosure further provides for a method for authorizing a sale of a product. An activation key is sent from a point of sale device to a key management system. It is determined if the activation is found in the key management system. If so, a sale at a point of sale of the product is authorized.

In further embodiments, it is determined if the activation key is associated with a valid merchant identifier and terminal identifier. The sale of the product is allowed to continue if the activation key is associated with a valid merchant identifier and terminal identifier. A purchaser receives a copy of the activation key associated with the product at time of purchase.

The present disclosure further provides for a method for authorizing an online installation of a product. The online installation of the product is initialized. An activation key is conveyed to a key management system. It is determined if a copy of the activation key is found in an activation key table of the key management system. If the copy of said activation key is found in the activation key table, it is determined if the activation key has a positive acquired attribute and a negative installation attribute. The installation associated with said product is continued if the activation key has a positive acquired attribute and a negative activation attribute.

In various embodiments, the activation attribute is set to positive after an installation of said product. The activation key is conveyed through a member selected from the group consisting of an Internet and through an intermediary retailer.

The present disclosure further provides a method for authorizing an offline installation of a product. An installation associated with the product is initiated. An activation key is conveyed to a customer service. The activation key is conveyed from said customer service to a key management system. It is determined by the key management system if the activation key exists. If it exists, a corresponding serial ID is determined that is associated with the activation key. An offline code is generated correlating to the serial ID. The offline code is conveyed to a user from the key management system through the customer service. An installation is of the product is permitted if an embedded serial ID correlates to the offline code.

In various embodiments, the installation of the product is permitted if an acquired attribute of the activation key in an activation key table within the key management system is positive and an activated attribute of the activation key in the activation key table is negative.

The present disclosure further provides a method of manufacturing a product in a package. An activation key is generated. An associated serial identifier is also generated. A copy of the activation key and the serial identifier are sent to a key management system. A copy of the activation key is placed on the package. A copy of the associated serial identifier is embedded in the product.

In various embodiments, the copy of said activation key is placed so that the activation key is readable by a point of sale device.

The present disclosure further provides a system for authorizing an online installation of the product using a key management system. A database has an activation key table and a serial ID table. An input device inputs an activation key during an online installation. A backend system compares the activation key with the activation key table to determine if the activation key is found in the activation key table and denies the installation if the activation key is not found in the activation key table. The activation key table further comprises an acquired attribute; and an activation attribute. The backend system denies an installation if the acquired attribute is set for negative for the activation key. The backend system denies an installation if the activated attribute is set for positive for the activation key. The backend system compares a stored serial ID correlated to the activation key to an embedded serial ID within the product. The backend system authorizes an installation of the product if the stored serial ID correlates to the embedded serial ID.

In further embodiments, the backend system denies the authorization of the installation of the product if the stored serial ID does not correlate to the embedded serial ID.

### BRIEF DESCRIPTION OF THE DRAWINGS

FIG. 1 is a system diagram of a product point of sale (POS) activation system.

FIG. 2 is a method of manufacturing a product with an activation key number and an embedded serial identifier (“serial ID,” such as numbers, letters, alphanumeric codes, and so on).

FIGS. 3 and 4 are a method for purchasing an activation key and a corresponding embedded serial id.

FIGS. 5 and 6 are a method for online activation of a product containing the activation key.

FIGS. 7 and 8 are a method for offline activation of a product containing the activation key.

### DETAILED DESCRIPTION OF THE PREFERRED EMBODIMENT

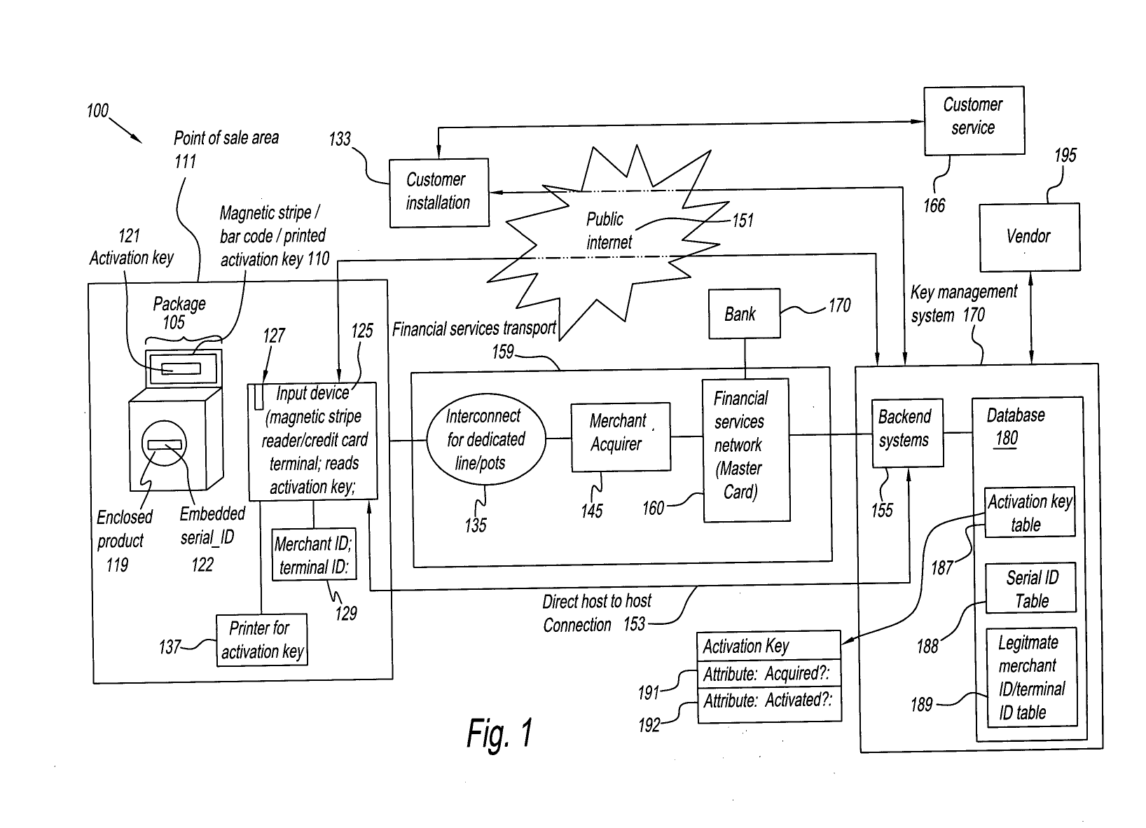

FIG. 1 illustrates a POS activation system (“system”) 100. System 100 has a point of sale area (POS) 111, a financial services transport 159, a direct host-to-host connection 153, a public internet connection 151, a key management system (KMS) 170, customer service 166, customer installation 133, and a vendor 195.

POS 111 has package 105. Package 105 has a magnetic stripe 110. An activation key 121 is found within magnetic stripe 110, and is generally visible or otherwise detectable without opening or otherwise compromising package 105, although magnetic stripe 110 can also be a bar code. Alternatively, activation key 121 is printed on package 105.

Generally, activation key 121 is used by KMS 170 to determine if a product 119, within package 105, was legitimately acquired. This determination occurs, for instance, when buying product 119 or installing product 119. In the present application, installing can also mean enabling. Product 119 can be generally defined as an article that has been manufactured that does not require continual service from a service provider to use the product. An example of product 119 is software. Magnetic stripe 110 can be alternatively, for instance, a bar code, or other related technologies that can be used in optical scanners or magnetic stripe readers.

FST 159 is coupled to POS 111. Generally, FST 159 acts as an interface between POS 111 and KMS 170. Alternatively, a direct host-to-host connection 153 also couples POS 111 and KMS 170. In yet another embodiment, a public internet 151 is coupled between POS 111 and KMS 170. A customer installation 133 for installing product 119 is also coupled to public Internet 151. Any of these can be used for conveying activation key 121 or installing product 119, as will be detailed below.

In a first embodiment, a process of installation of product 119 occurs online using public internet 151. A user of product 119 enters activation key 121 into product 119 at a time of installation, which sends it to KMS 170 to determine whether activation key 121 has already been activated by another user. If it is not in use, and activation key 121 is otherwise legitimately acquired, KMS 170 then checks a stored serial ID from a serial ID table 188 against embedded serial ID 122. If these values match, KMS 170 activates product 119. If these values do not match, KMS 170 does not activate product 119.

In a second embodiment, to activate product 119, the installation is desired to be performed offline. Therefore, the purchaser acquires via printer for activation key 137 a print-out of activation key 121 at time of sale in POS area 111. Then, when installing offline, the user contacts a customer service 166, which is coupled to KMS 170, and provides activation key 121, received from POS area 111. If activation key 121 passes the various tests associated with it (was it properly acquired, and so on, as will be detailed below), an offline code is conveyed to customer installation 133 by a customer service 166 to be used in the installation of product 119, correlating to a serial ID in serial ID table 188. This received offline code is compared by a serial ID comparator within product 119 to determine whether to install or not to install product 119.

Furthermore, although embedded serial ID 122 and offline code can be copies of one another, it is not necessary that they are so. Although there should be a correlation as determined by the serial ID comparator inside product 119, this relationship can be determined by, for instance, an encryption algorithm inside product 119 that examines an encrypted serial ID 122 and an encrypted offline code to see if they correlate. Since the activation key 121 on the package relates to the embedded serial ID 122 inside product 119, then KMS 170 can provide an offline code that correlates to the serial ID 122, whether encrypted or not.

Package 105 does not need to be kept in a separate, secure area. This is because, in system 100, product 119 can not be initialized or activated without a user conveying activation key 121 to KMS 170, KMS 170 verifying that activation key 121 has been legitimately acquired and not yet activated, and product 119 either receiving an offline code against which to compare embedded serial ID 122 (offline scenario), or KMS 170 comparing the corresponding serial ID in serial ID table 188 to embedded serial ID 122 (online scenario).

Product 119 has intelligence. In other words, there is a degree of enablement that is necessary to occur for an installation to take place and for product 119 to be useful. If the installation does not occur, product 119 does not function properly, perhaps not at all.

More specifically, POS area 111 has an input device 125 with a reader 127. Input device 125 can be a credit card authorization terminal or a point of sale terminal or a cash register. Reader 127 can be, for instance, a magnetic stripe swipe reader. Input device indicia 129 is associated with input device 125. Input device indicia 129 are the merchant_ID (i.e., who the merchant is), and a terminal_ID (i.e., what is the terminal identifier of input device 125). A printer for activation key 121 may also be coupled to input device 125, or integrated into input device 125.

Input device 125 is coupled to an interconnect 135 of FST 159. Interconnect 135 can be a dedicated line, a plain old telephone system (POTS) connection, or some other connection. Interconnect 135 is coupled to a merchant acquirer 145.

Generally, merchant acquirer 145 acts as a switch for various types of financial transactions. In other words, merchant acquirer 145 receives retailer credit card transactions, and then aggregates the orders and determines what type of credit card or debit card it is, and then passes the order on to the appropriate bank via financial services network 160, while taking a fee for the transaction.

For instance, in system 100, financial services network 160 sends transactions either to KMS 170, retailers or banks. If activation key 121 is received by financial services network 160, activation key 121 is routed to KMS 170.

KMS 170 has backend systems 155 and a database 180. Generally, backend systems handles database 180, and other interface needs of KMS 170, along with interactions with vendor 195, customer installation 133 and transactions from point of sale area 111.

Database 180 has a legitimate activation key table 187, a serial ID table 188, and a legitimate merchant ID/terminal ID table 189 (“merchant table 189”). Activation key table 187 has an “acquired” attribute 191, an “activated” attribute 192.

Database 180 is also coupled to vendor 195. Database 180 receives activation key table 187, serial ID table 188, and merchant table 189 from vendor 195. Furthermore, database 180 updates vendor 195 when attributes 191-192 of activation key table 187 are set.

Generally, backend systems 155 uses the data in database 180 to determine, as will be explained below, whether a received value that is being presented as activation key 121 input device 125 is a legitimate activation key 121, as compared against activation key table 187. If activation key 121 is legitimate (i.e., it is found in the table), then attribute 191 of activation key 121 is set to a positive “acquired,” within activation key table 187, and the user may finish the purchase of the product.

In order to accomplish this, backend systems 155 compares allowable activation keys in activation key table 187 with a received activation key 121 from POS area 111 to determine if there is a match. If there is a match, then activated attribute 192, and merchant ID terminal ID 129 and legitimate merchant ID/terminal ID table 189 are compared and/or determined, as will be described below. If all attributes check, then the retailer user of input device 125 is so notified and the sale is allowed to complete and “acquired” attribute 191 is set to positive. If not, the sale is blocked by database 180, as the activation key 121, received from input device 125, does not match an allowable activation key within legitimate key table 187 or the merchant ID terminal ID 129 is not valid or the other attributes 191-192 do not allow the sale to continue.

In one embodiment, it is also determined whether activation key 121 originates from a proper retail outlet, as determined by a comparison between merchant ID/terminal ID 129 and an entry in activation key table 187 corresponding to merchant table 189. If activation key 121 does not originate from an authorized retail outlet, the point of sale product activation fails. Legitimate retail outlet table 189 is received from vendor 195.

In the first embodiment of online activation, customer installation 133 contacts key management system 170 to activate product 119. Key management system 170 either grants or denies permission for this. This determination is performed by testing the newly-received activation key 121, conveyed from customer installation 133, against activation key table 187, both for existence, a positive acquired attribute 191, and for a negative activation attribute 192.

If activation key 121 is not found in activation key table 187, then product 119 is not legitimate, and installation/activation of product 119 is denied. If activation key 121 is found as having a negative acquired 191 attribute, then product 119 was not legitimately purchased, and installation/activation of product 119 is denied. However, even if activation key 121 is in activation key table 190 and attribute acquired 191 is positive, if activation key 121 is found as having a positive activation attribute 192 within activation key table 187, that activation key 121 is therefore already installed, and KMS 170 denies the activation. If attribute activated 192 is negative, KMS 170 allows the installation and/or activation to continue. This occurs by KMS comparing its serial ID table 188 to embedded serial ID 122 to determine if there is a match. If there is a match, installation continues.

KMS 170 then also toggles activation attribute 192 for activation key 121 into positive for activated activation key status table 192, as this key is now activated. This positive acquisition status 192 is then to be compared against further activations of products through use of received activation keys 121.

In the second embodiment of offline activation, when a purchaser purchases product 119 and contacts customer service 166 and supplies activation key 121, customer service checks backend systems 155 to determine, through a comparison of activation key 121 to activation key table 187, if activation key 121 is in activation key table 187. It also checks the acquired attribute 191, activated attribute 192, to see if product 199 was properly acquired and whether it was already activated. If not then customer service does not provide the purchaser with the offline code required for installing the software product. Backend systems 155 determine what the corresponding serial ID 122 is for activation key 121 through accessing serial ID table 192.

KMS 170 then generates an offline code as a function of the corresponding serial ID 122 stored in serial ID table 188, and conveys this offline code to customer service 166, which provides the offline code to the user at customer installation 133, so that offline code can be entered into product 119 and can activate product 119 by the user offline. Product 119 then checks to see if the offline code correlates to embedded serial ID 122. If it does, installation continues. If it does not correlate, installation stops.

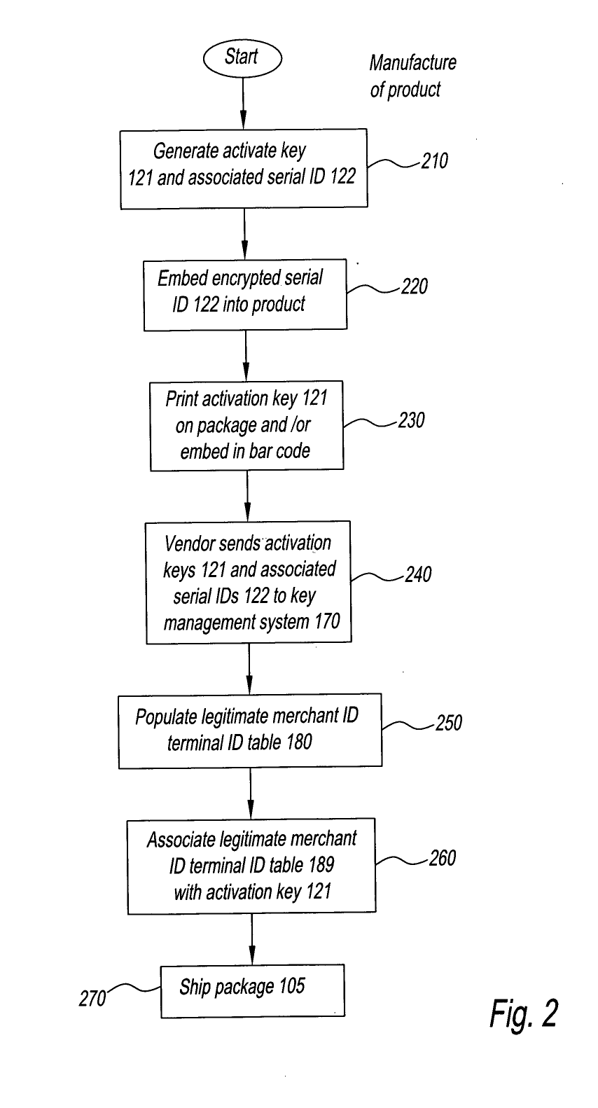

FIG. 2 is an illustration of a method 200 for manufacturing product 119 with magnetic stripe 110. Activation key 121 can be randomly generated. Method 200 places activation key 121 on package 105.

After starting, in step 210, activation key 121 and an associated embedded serial ID are generated. Method 200 advances to step 220.

In step 220, the vendors encrypt serial ID and embed as embedded serial ID 122 into product 119, such as a CD. Step 220 then advances to step 230.

In step 230, activation key 121 is embedded in magnetic stripe 110 or printed on outside of box 105. Step 230 then advances to step 240.

In step 240, vendor 195 sends activation key 121 from vendor products database 185 to activation key table 187 in database 180. Vendor 195 also sends the associated serial ID to serial ID table 188. Step 240 advances to step 250.

In step 250, merchant table 189 is populated by vendor 195. Method 200 advances to step 260.

In step 260, entries in merchant table 189 is associated with activation key 121. Method 200 advances to step 270.

In step 270, package 105 is shipped. Method 200 ends.

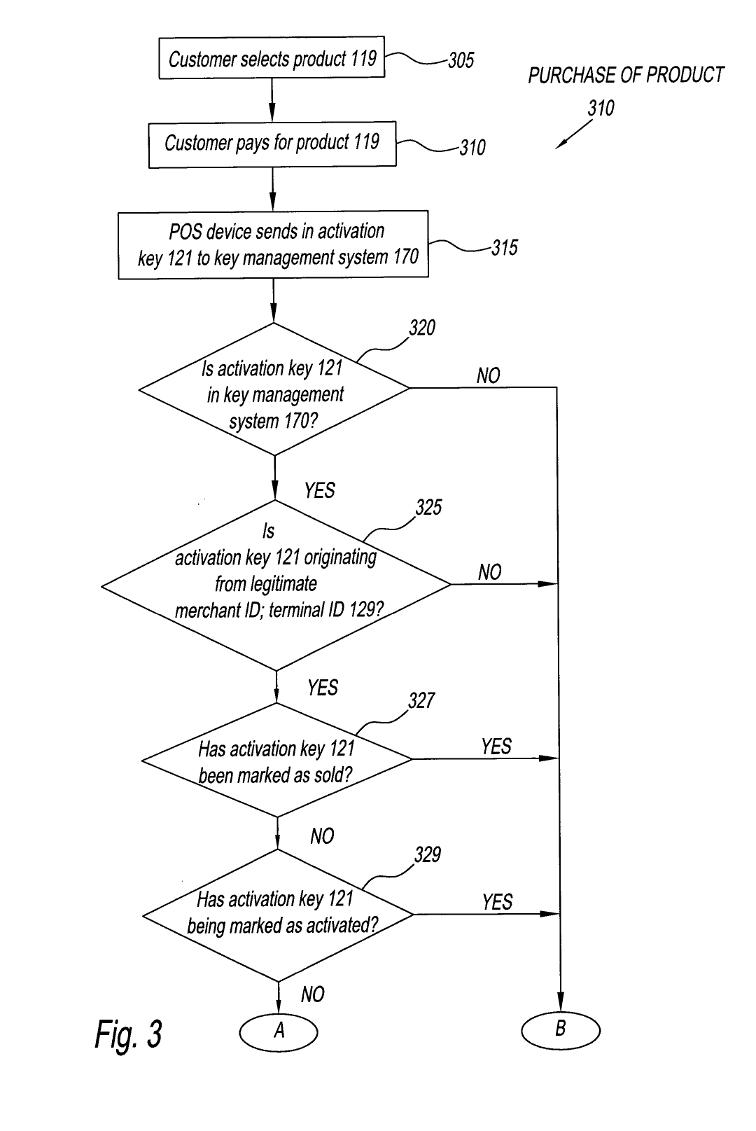

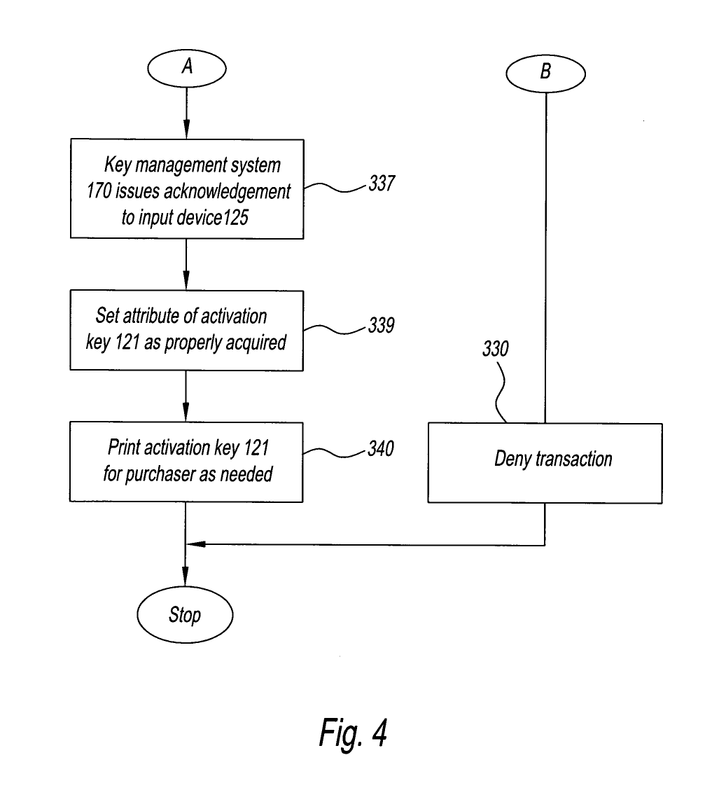

FIGS. 3 and 4 illustrate a method 300 for point of sale purchase of product and determining whether product 119 having activation key 121 should be sold by a retailer, based upon accessing legitimate activation key table 187. Generally, method 300 compares received activation key 121 to entries in activation key table 187 to determine whether a sale of product 119 should or should not take place.

In step 305, a customer selects product 119 having activation key 121. The selection is typically made off the shelf, with no extra security measures needed, as KMS 170 has to confirm the acquired 191 attribute in activation key 121 in order to allow an installation of product 119. Method 300 then advances to step 310.

In step 310, the customer pays for product 119. Method 300 advances to step 315.

In step 315, POS 125 sends activation key 121, read from magnetic stripe 110 to KMS 170. Furthermore, in step 315, input device 125 also conveys merchant ID/terminal ID 129. This can occur over public Internet 151, FST 159, or direct host-to-host connection 153, or other conveyance technologies. Step 315 advances to step 320. Alternatively, an intermediate retailer (not illustrated) can also be employed to convey activation key 121.

In step 320, it is determined by backend systems 155 whether activation key 121 is an allowable activation key by determining if activation key 121 corresponds to an entry in activation key table 187. If activation key 121 is not in activation key table 187, step 320 advances to step 330, and purchase is denied. If activation key 121 is in activation key table 187, method 300 advances to step 325.

In one embodiment, in step 325, it is determined if activation key 121 is received from an authorized reseller. This is performed by comparing merchant ID/terminal ID 129 with an entry in legitimate merchant ID/terminal ID table 189 associated with activation key 121. If input device 125 is associated with an authorized reseller, step 325 advances to step 335. Otherwise, step 325 advances to step 330, and purchase is denied.

In step 327, it is determined if acquired attribute 191 is already positive. If it is, method 300 advances to step 330 and transaction is denied. Otherwise, method 300 advances to step 329.

In step 329, it is determined if activation attribute 192 is already positive. If it is, method 300 advances to step 330 and transaction is denied. Otherwise, method 300 advances to step 337.

In step 337, an acknowledgement of the sale is sent to the retailer, the controller of input device 125, that the sale is acceptable to KMS 170 as determined through accessing activation key table 187. Method 300 advances to step 339.

In step 339, activation attribute 192 is set as positive. Method 300 advances to step 340.

In step 340, activation key 121 is printed for purchaser as needed (i.e., if activation key 121 is embedded in a bar code, etc.). For example, activation key 121 may get printed on a sales receipt. Method 300 then ends.

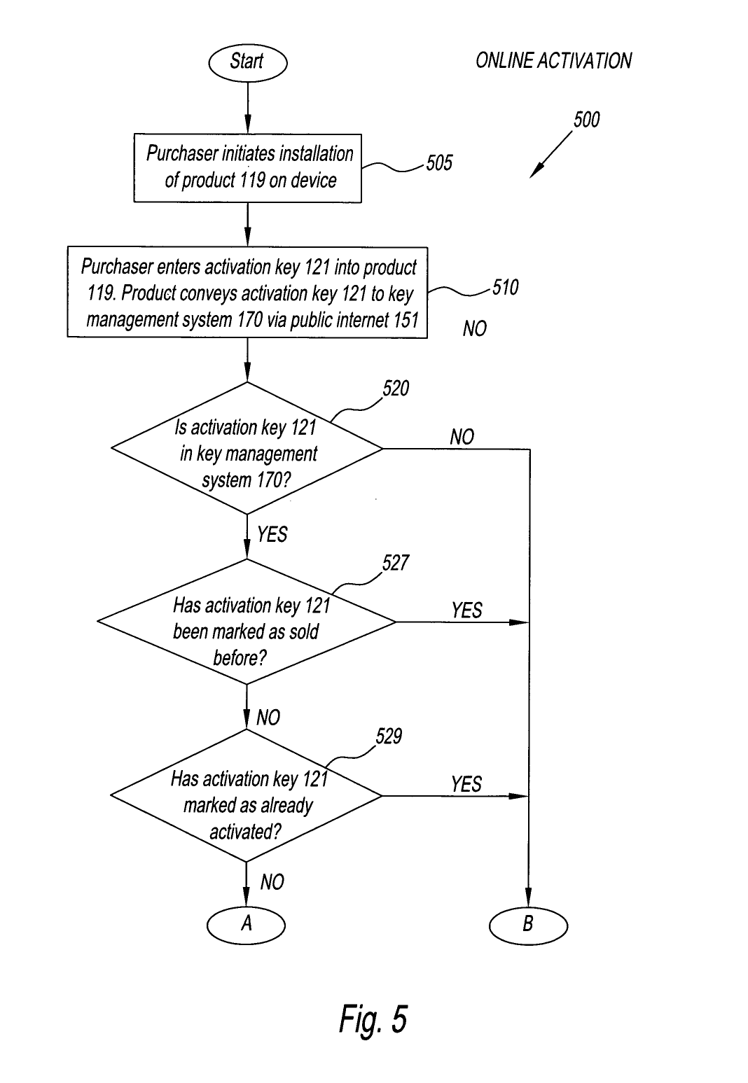

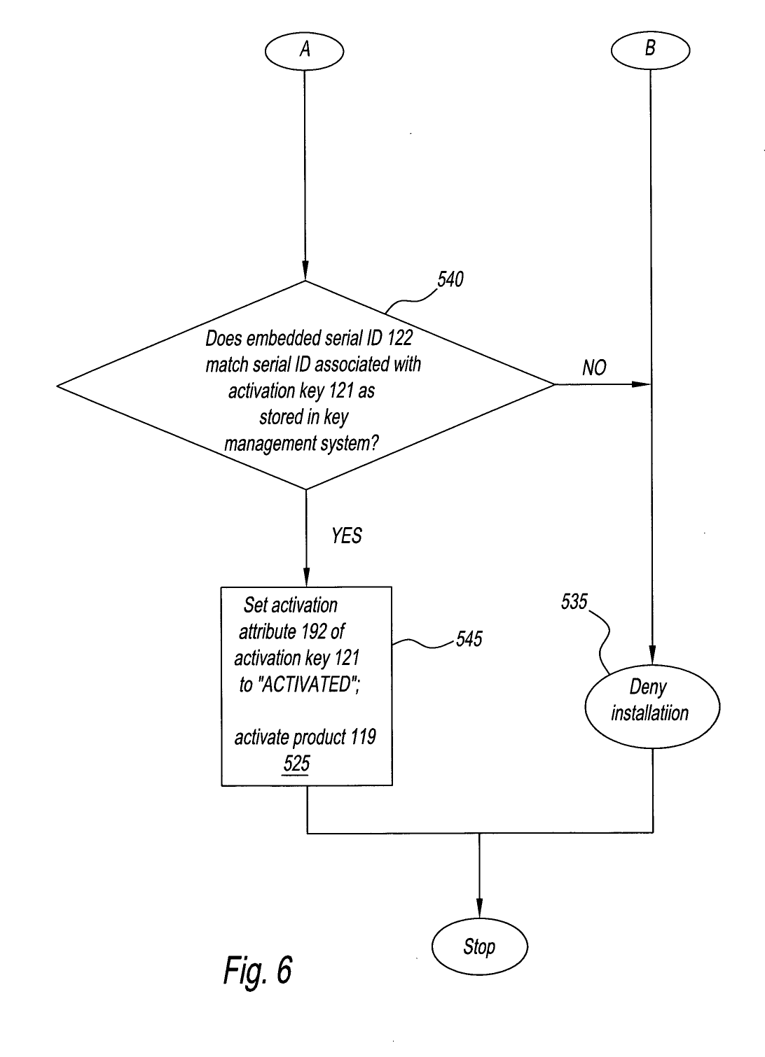

FIGS. 5 and 6 illustrate a method 500 for online activation or initialization of product 119 over the Internet. Generally, method 500 determines whether activation key 121, this time received by KMS 170 during installation/activation, is found in activation key table 187, and if so, does it have a positive acquired attribute 191, but a negative activated attribute 192. If this condition is not met, database 180 denies activation/installation. It also checks to see if product 119 has been properly acquired and if it has already been activated, and that serial ID in serial ID table 188 associated with activation key 121 matches embedded serial ID 122.

In step 505, purchaser begins to install product 119 on a device, such as a home PC, at customer installation 133. Step 505 advances to step 510.

In step 510, the purchaser, during the initiation of the installation/activation process at customer installation, enters activation key 121 into product 119, which conveys activation key 121 to KMS 170, such as through public Internet 151. Step 510 advances to step 520.

In step 520, database 180 determines if conveyed activation key 121 is found in activation table 187. If it is not, step 515 advances to step 535, and method 500 stops, and activation/installation is denied. If activation key 121 is found in activation table 187, then step 515 advances to step 527.

In step 527, it is determined if acquired attribute 191 is already positive for activation key 121. If it is, method 500 advances to step 535 and installation is denied. Otherwise, method 500 advances to step 529.

In step 529, it is determined if activated attribute 192 is already positive. If it is, method 500 advances to step 535 and installation is denied. Otherwise, method 500 advances to step 540.

In step 540, KMS 170 queries embedded serial ID 122 to determine if it matches a serial ID associated with activation key 121 and stored in serial ID table 188. If it does, method 500 advances to step 534. If it does not, method 500 goes to step 535, and denies installation.

In step 545, database 180 sets activation attribute 192 to positive, and activated product 119. Product is allowed to be activated at customer installation 133. Method 500 ends.

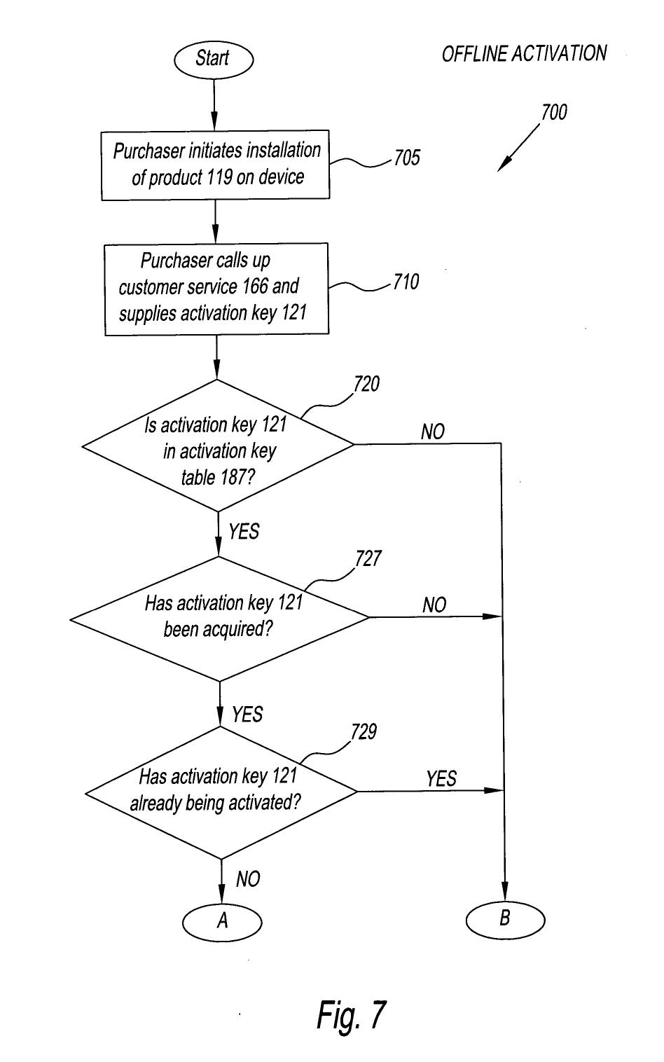

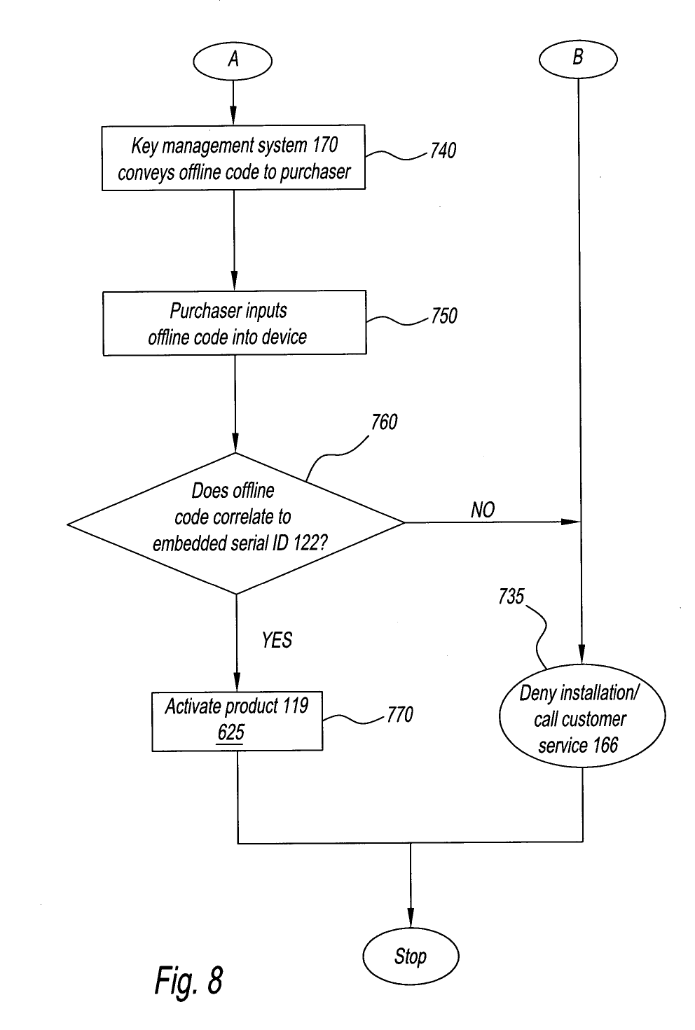

FIG. 7 illustrates a method 700 for activating product 119 without the use of the Internet or other online connection by consumer installation 133 to key management system 170. Generally, method 700 determines whether activation key 121, conveyed to customer service 166 by phone during installation/activation, is found in activation key table 187, and if so, does it have a positive acquired attribute 191, but a negative activated attribute 192. If this condition is not met, database 180 informs customer service that it should not provide the appropriate activation key to he user. Method 700 also checks to see if product 119 has been properly acquired and if it has already been activated, and that serial ID in serial ID table 188 associated with activation key 121 matches embedded serial ID 122.

In step 705, purchaser begins to install product 119 on a device, such as a home PC. Step 705 advances to step 710.

In step 710, the purchaser, during the initiation of the installation/activation process at customer installation, calls up customer service 166 and supplies activation key 120. Step 710 advances to step 720.

In step 720, backend systems 155 determines if conveyed activation key 121 is found in activation table 187. If it is not, step 720 advances to step 735, and method 700 stops, and activation/installation is denied. If activation key 121 is found in activation table 187, then step 720 advances to step 727.

In step 727, it is determined if acquired attribute 191 is positive for activation key 121. If it is not, method 700 advances to step 735 and installation is denied. Otherwise, method 700 advances to step 729.

In step 729, it is determined if activated attribute 192 is already positive. If it is, method 700 advances to step 735 and installation is denied. Otherwise, method 700 advances to step 740.

In step 740, customer service 166 supplies offline code to purchaser. Activation key 121 attribute 192 activated is set to true. Method 700 advances to step 750.

In step 750, purchaser enters offline code into enclosed product 119. Method 700 advances to step 760.

In step 760, product 119 determines if offline code correlates with embedded serial ID 122. If it does, method 700 advances to step 770. If it does not, method 700 goes to step 735, and denies installation.

In step 770, product 119 is activation and installation proceeds. Method 700 ends.

It should be understood that various alternatives, combinations and modifications of the teachings described herein could be devised by those skilled in the art. The present invention is intended to embrace all such alternatives, modifications and variances that fall within the scope of the appended claims.

What is claimed is:

1. A system for authorizing a sale of a product at a point of sale, comprising;
a database having an activation key table;
an input device that inputs an activation key during a point of sale transaction; and
a backend system that compares said activation key with said activation key table to determine if a copy of said activation key is found in said activation key table and denies said point of sale transaction if said copy of said activation key is not found in said activation key table.

2. The system of claim 1, wherein said activation key table has at least one attribute selected from the group consisting of: an acquired attribute and an activation attribute.

3. The system of claim 2, wherein said attribute is said acquired attribute and said backend system sets said acquired attribute to a positive acquired attribute after an authorized sale of the product.

4. The system of claim 1, wherein said activation key table is received from a vendor.

5. The system of claim 1, further comprising a serial identification (ID) table that contains a serial ID, wherein said serial ID corresponds to a stored activation key in said activation key table.

6. The system of claim 1, wherein said input device includes at least one identifier selected from the group consisting of: a merchant identifier and a terminal identifier.

7. The system of claim 1, further comprising an activation key conveyor that couples said input device and said backend system is at least one selected from the group consisting of: a financial services transport, a public internet, and a host to host connection.

8. The system of claim 1, wherein a packaging of the product has a magnetic strip readable by said input device, wherein said activation key is contained within said magnetic strip.

9. The system of claim 1, wherein said input device is a credit card reading machine.

10. A system for authorizing an offline installation of a product with a key management system, comprising;
a database having an activation key table and a serial ID table;
an input device hat inputs an activation key during an offline installation;
a backend system,
a customer service coupled to said database;
wherein said backend system compares said activation key with said activation key table to determine if said activation key is found in said activation key table and denies said installation if said activation key is not found in said activation key table; and
wherein said backend system conveys an offline code that correlates to said stored serial ID within said serial ID table to said customer service, said offline code being associated with said activation key.

11. The system of claim 10, wherein said activation key table comprises at least one attribute selected from the group consisting of: an acquired attribute and an activation attribute.

12. The system of claim 11, wherein said attribute is said activation attribute and said backend system compares said activation attribute associated with said activation key;
if said activation attribute is negative, said backend system activates said product; and
if said activation attribute is positive, said backend system stops an activation of said product.

13. The system of claim 11, wherein said activation attribute is set to positive if said backend system activates the product.

14. The system of claim 11, wherein the product has intelligence.

15. The system of claim 10, wherein the product has an embedded serial ID, wherein said serial ID is compared against a serial ID associated with said activation key of the product in said serial ID table to enable installation of the product.

16. A method for authorizing a sale of a product, comprising:
sending an activation key from a point of sale device to a key management system;
determining if said activation is found in said key management system; and
authorizing a sale at a point of sale of the product if said activation key is found in said key management system.

17. The method of claim 16, further comprising:
determining whether said activation key is associated with a valid merchant identifier and/or terminal identifier; and
allowing said sale of the product to continue if said activation key is associated with a valid merchant identifier and/or terminal identifier.

18. A method for authorizing an online installation of a product, comprising:
initializing the online installation of the product;
conveying an activation key to a key management system;
determining if a copy of said activation key is found in an activation key table of said key management system;
determining, if said copy of said activation key is found in said activation key table, if said activation key has a positive acquired attribute and a negative installation attribute; and
continuing said installation associated with the product if said activation key has a positive acquired attribute and a negative activation attribute.

19. The method of claim 18, further comprising setting said activation attribute to positive after an installation of the product.

20. The method of claim 19, further comprising conveying said activation key through a member selected from the group consisting of: an Internet and through an intermediary vendor.

21. A method for authorizing an offline installation of a product, comprising:
initializing an installation associated with the product;
conveying an activation key to a customer service;
conveying said activation key from said customer service to a key management system;
determining if said activation key exists by said key management system;
if it exists, determining a corresponding serial ID associated with said activation key;
generating an offline code correlating to said serial ID;
conveying said offline code to a user from key said key management system through said customer service; and
permitting an installation of the product if an embedded serial ID correlates to said offline code.

22. The method of claim 21, further comprising permitting said installation of the product if an acquired attribute of said activation key in an activation key table within said key management system is positive and an activated attribute of said activation key in said activation key table is negative.

23. A system for authorizing an online installation of a product through employment of a key management system, comprising;
a database having an activation key table and a serial ID table;
an input device that inputs an activation key during an online installation;
a backend system, wherein said backend system compares said activation key with said activation key table to determine if said activation key is found in said activation key table and denies said installation if said activation key is not found in said activation key table;
wherein said activation key table further comprises at least one attribute selected from the group consisting of: an acquired attribute and an activation attribute;
wherein said backend system denies an installation if said acquired attribute is set for negative for said activation key;
wherein said backend system denies an installation if said activated attribute is set for positive for said activation key,
wherein said backend system compares a stored serial ID correlated to said activation key to an embedded serial ID within the product; and
wherein said backend system authorizes an installation of the product if said stored serial ID correlates to said embedded serial ID.

24. The system of claim 23, wherein said backend system denies said authorization of said installation of the product if said stored serial ID does not correlate to said embedded serial ID.

25. The system of claim 24, wherein said serial ID is encrypted.

26. The system of claim 23, wherein said input devices comprises a computer keyboard.
